(19) United States
(12) Patent Application Publication
(10) Pub. No.: US 2006/0161413 A1
(43) Pub. Date: Jul. 20, 2006

(54) Methods for fast and large circuit simulation

(75) Inventors: You-Pang Wei, Los Altos, CA (US); Heng-Liang Huang, Hsin-Chu (TW); Scott (Shih-Chia) Lin, Sunnyvale, CA (US); Hung-Ta Wei, San Jose, CA (US); Adrian Wen, Taipei City (TW); Shu Wu, Sunnyvale, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Legend Design Technology, Inc., Santa Clara, CA (US)

(21) Appl. No.: 11/332,603

(22) Filed: Jan. 13, 2006

Related U.S. Application Data
(60) Provisional application No. 60/644,099, filed on Jan. 14, 2005.

(51) Int. Cl. G06F 17/50

(52) U.S. Cl. 703/14

(57) ABSTRACT

A method for simulating large circuits in full-scale. To enhance the simulation efficiency, subcircuits are extracted from a circuit and thence a hierarchical structure is established using the extracted subcircuits. Subsequently, the circuit is partitioned and a current-voltage table for each subcircuit is dynamically generated. A transient analysis of the circuit is preformed at each incremental time step and a recursive latency check is preformed from the top to the bottom level of the hierarchical structure to determine the active part of the circuit. Using the current-voltage curves, a portion of the conductance matrix corresponding to the active part is rebuild at each incremental time step, which significantly reduces the simulation time.

### CROSS REFERENCE TO RELATED APPLICATIONS

This application claims the benefit of U.S. Provisional Application No. 60/644,099, entitled “Method for Fast and Large Circuit Simulation,” filed on Jan. 14, 2005, which is hereby incorporated herein by reference in its entirety.

### FIELD OF THE INVENTION

The present invention generally relates to computer-aided design tools, and more particularly methods for simulating circuits using a hierarchical data structure and executing latency check with a given or automatically extracted hierarchy.

### BACKGROUND OF THE INVENTION

Circuit simulation is an important step in microelectronic circuit design. Prior to the actual fabrication of a new circuit, design engineers can check the performance and validate the intended functionality of the new circuit through a circuit simulation.

In general, most of the circuits are given in hierarchical structures due to the complexity and design reusability. However, existing simulation tools, such as SPICE, perform device-level circuit simulations, i.e., any hierarchically structured circuit may be flattened prior to the circuit simulation. However, as the device-level simulation is realized by solving a set of mathematical equations and each equation corresponds to an element or device of the circuit, the device-level simulation requires a considerable amount of memory. By way of example, a memory of 1 G bytes is required to simulate a circuit containing 10 million devices. Thus, a typical simulation tool cannot perform a full simulation of 256 M DRAM chip that contains 256 million transistors at the device-level. Accordingly, the device-level simulation is limited to the simulation of small subcircuit blocks. In addition, solving the equations can be time-consuming and, as a consequence, the cost of simulating a circuit becomes non-trivial.

Thus, there is a strong need for a method for reducing the memory and time consumed during a circuit simulation. Also, a new approach is needed to allow a circuit design engineer to achieve full-chip simulation of circuits, where the size of circuits is rapidly growing in the current electronic technology.

### SUMMARY OF THE INVENTION

The present invention provides a method for simulating large circuits in full-scale. To enhance the simulation efficiency, the present invention exploits dynamic simulation of only active parts of the circuits during the transient behavior simulation, wherein the circuit is rebuilt in a hierarchical structure prior to the simulation. Also, to minimize the memory and time consumption, dynamic modeling of current-voltage tables for circuit elements is used in the present invention.

In one aspect of the present invention, a method for simulating a behavior of a circuit includes steps of: extracting one or more subcircuits from a circuit; establishing a hierarchical structure of the extracted subcircuits; partitioning the circuit to refine the established hierarchical structure; dynamically modeling a current-voltage table for each of said subcircuits; and performing a transient analysis of an active portion of the circuit at each incremental time step, the transient analysis including a recursive latency check from the top level to the bottom level of the hierarchical structure to determine the active portion of the circuit and updating the active portion based on the table

These and other features, aspects and advantages of the present invention will become better understood with reference to the following drawings, description and claims.

### BRIEF DESCRIPTION OF THE DRAWINGS

FIG. 1 shows a flow chart illustrating the steps that may be carried out to extract subcircuits contained in a circuit according to the present invention;

FIG. 2 shows a flow chart illustrating the steps that may be carried out to build a hierarchical structure of a circuit in accordance with the present invention;

FIG. 3A illustrates an exemplary step of building a topology for a node and three subcircuits in accordance with the present invention;

FIG. 3B illustrates an exemplary step of creating a new subcircuit based on the topology established in FIG. 3A;

FIG. 3C illustrates an exemplary step of pushing a coupling capacitor into a subcircuit in accordance with the present invention;

FIG. 3D illustrates an exemplary conductance matrix of a subcircuit in accordance with the present invention;

FIG. 3E shows an exemplary step of merging parallel subcircuit instances in accordance with the present invention;

FIG. 4 shows a flow chart illustrating the steps that may be carried out to partition a circuit in accordance with the present invention;

FIG. 5A illustrates an exemplary step of partitioning a circuit on the nodes that have resistor/inductor/voltage-source (R/L/V) paths to ground in accordance with the present invention;

FIG. 5B illustrates an exemplary step of grouping DC-connected components as subcircuits and partitioning the subcircuits by use of the Min-Cut algorithm in accordance with the present invention;

FIG. 6 shows a flow chart illustrating the steps that may be carried out to dynamically model a current-voltage table for a MOS device;

FIGS. 7A-7B illustrate an exemplary piecewise-linear approximation of the current-voltage curve for a MOS device in accordance with the present invention;

FIG. 8A is an exemplary current-voltage table of a MOD device;

FIG. 8B is an exemplary current-voltage table of a MOSFET device;

FIG. 9 shows a flow chart illustrating the steps that may be carried out to hierarchically check latency in accordance with the present invention;

FIG. 10 shows a flow chart illustrating the steps that may be carried out to perform a transient analysis in accordance with the present invention;

FIG. 11 shows a schematic diagram of a circuit in a hierarchical structure in accordance with the present invention; and

FIG. 12 illustrates a conductance matrix of the circuit shown in FIG. 11.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a method for dynamic simulation of large circuits. The method may include the steps of extracting subcircuit patterns from a given circuit, building a hierarchical structure based on the extracted subcircuit patterns, and partitioning the circuit by characteristics and dynamically simulating the circuit. Unlike existing simulation tools, the present method may exploit a hierarchical architecture of the circuit and execute a recursive latency check from the top level of the hierarchical architecture to the device level so as to simulate only the active parts of the circuits yielding a considerable reduction in memory and time for simulation.

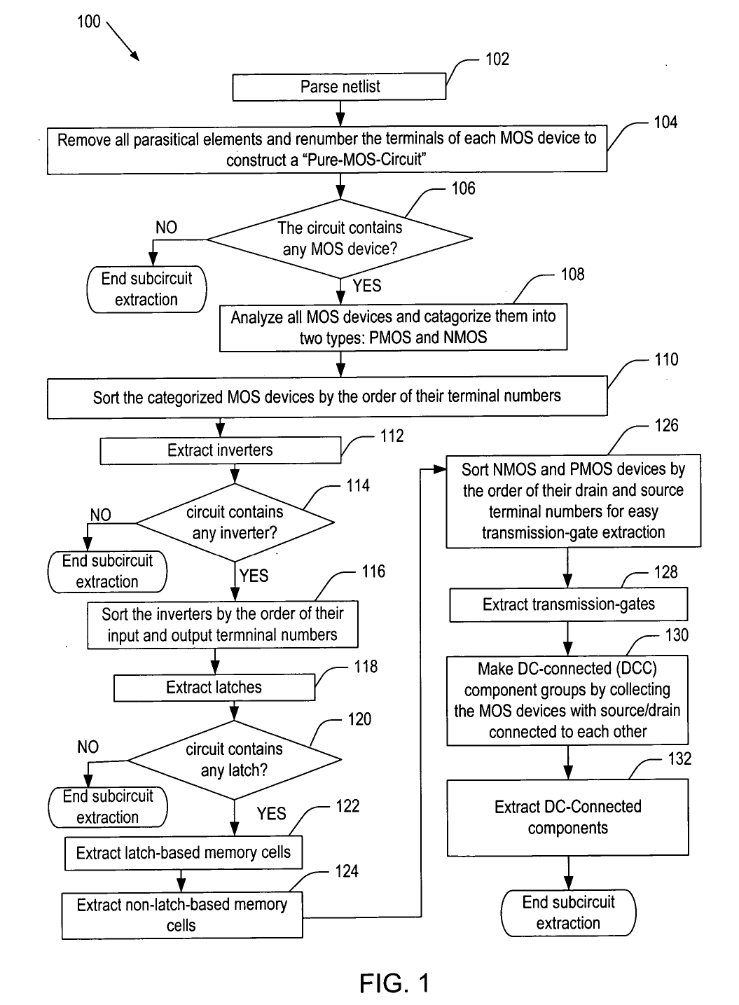

Referring now to FIG. 1, FIG. 1 is a flow chart shown at 100 and illustrates a process for extracting subcircuits from a circuit in accordance with the present invention. Hereinafter, the term subcircuit refers to a portion of the circuit that contains one or more MOS devices. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like.

The process may begin in a state 102. In the state 102, a netlist file (or, shortly, netlist) describing the circuit is parsed. By way of example, the netlist may be generated from a commercial schematic entry system and may follow the same syntax format required for running SPICE. The netlist may be a text file containing elements, such as capacitors, resistors and MOS devices. The data syntax may be in a flattened format or a hierarchical format. Then, the process may advance to a state 104.

In the state 104, parasitical elements, such as resistor, inductor and capacitor, may be removed from the circuit. Also, the terminals of each MOS device are renumbered to construct a “Pure-MOS-Circuit.” Typically, the overall design of a new circuit starts from gate voltage design to transistor voltage design and thence to physical layer design taking into account of resistors and capacitors. Thus, the state 104 may correspond to an early stage of the overall design. Then, the process may proceed from the state 104 to a state 106.

In the state 106, it is determined whether the circuit contains any MOS device (or, shortly, MOS). If answer to the state 106 is negative, the process may end. Otherwise, the process may proceed to a state 108. In the state 108, each of the MOS devices is analyzed and categorized into one of the two MOS types: NMOS and PMOS. Subsequently, in a state 110, the categorized MOS devices may be sorted by the order of their terminal numbers. Then, the process may proceed to a state 112.

In the state 112, one or more inverter devices (or, shortly, inverters) may be extracted from the sorted MOS devices. An inverter may contain one NMOS and one PMOS, where their gate terminals are connected to each other and a source terminal is connected to a drain terminal. Then, in a state 114, a determination as to whether the circuit contains any inverter is made. Upon negative answer to the state 114, the process may end. Otherwise, the process may proceed to a state 116.

In the state 116, the inverters may be sorted by the order of their input and output terminal numbers. Subsequently, in a state 118, latches are extracted, wherein a latch includes two inverters driving each other. Next, in a state 120, a determination as to whether the circuit contains one or more latches are is made. Upon negative answer to the state 120, the process may end. Otherwise, the process may process to a state 122.

In the state 122, latch-based memory cells may be extracted. In this state, each of the latches extracted in the state 118 may be analyzed to determine whether it is a latch-based memory cell considering the MOS devices around the cell and its bit-line/word-line properties. Then, in a state 124, each of the latches may be analyzed to determine whether it is a non-latch based memory. This step includes one-transistor memory cell extraction. Subsequently, the process may proceed to a state 126.

In the state 126, NMOS and PMOS are sorted by the order of their drain and source terminal numbers for easy transmission-gate extraction. Next, transmission gates may be extracted in a state 128, wherein the transmission gate contains one NMOS and one PMOS connected together by their drain and source terminals. Subsequently, the process may proceed to a state 130.

In the state 130, DC-connected component (DCC) groups may be generated by collecting MOS devices that have source/drain connected to each other. Then, in a state 132, DCC subcircuits may be extracted by recognizing each of the DCC groups. By way of example, the DCC subcircuits may be AND gate or NOR gate. Subsequently, the process for extracting circuits ends.

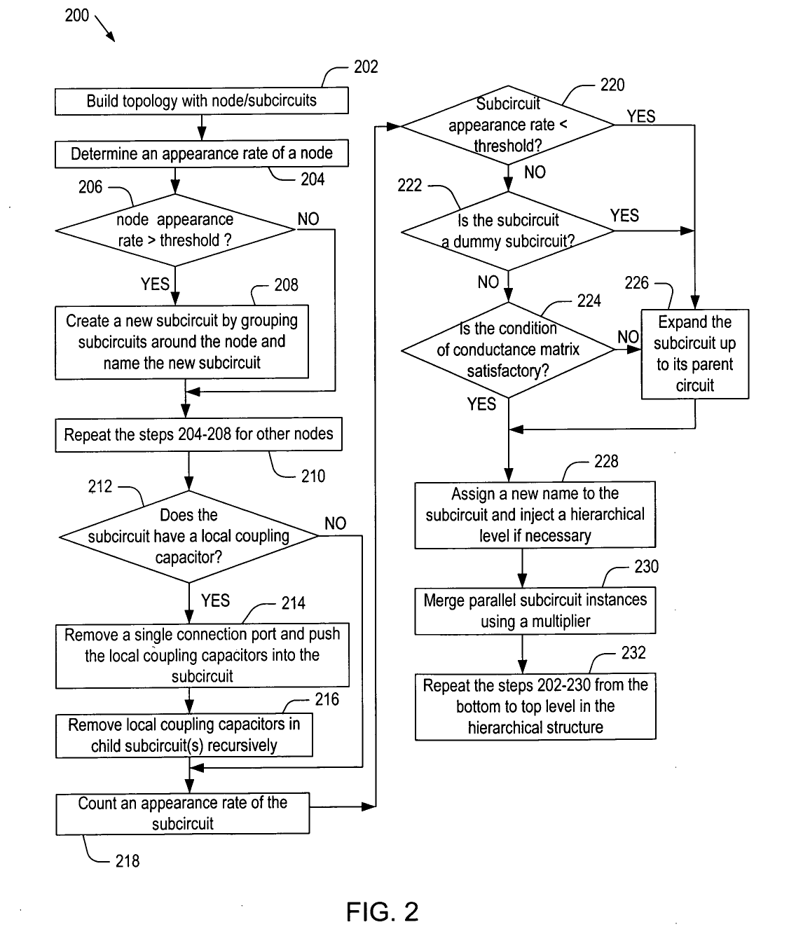

Upon completion of the subcircuit extraction process as depicted in FIG. 1, a circuit designer may count the number of subcircuits and components of the circuit. If the number of subcircuits is still too high for simulation, a hierarchical extraction may be performed on the circuit. FIG. 2 is a flow chart shown at 200 and illustrates a process for building a hierarchical structure of a circuit in accordance with the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like.

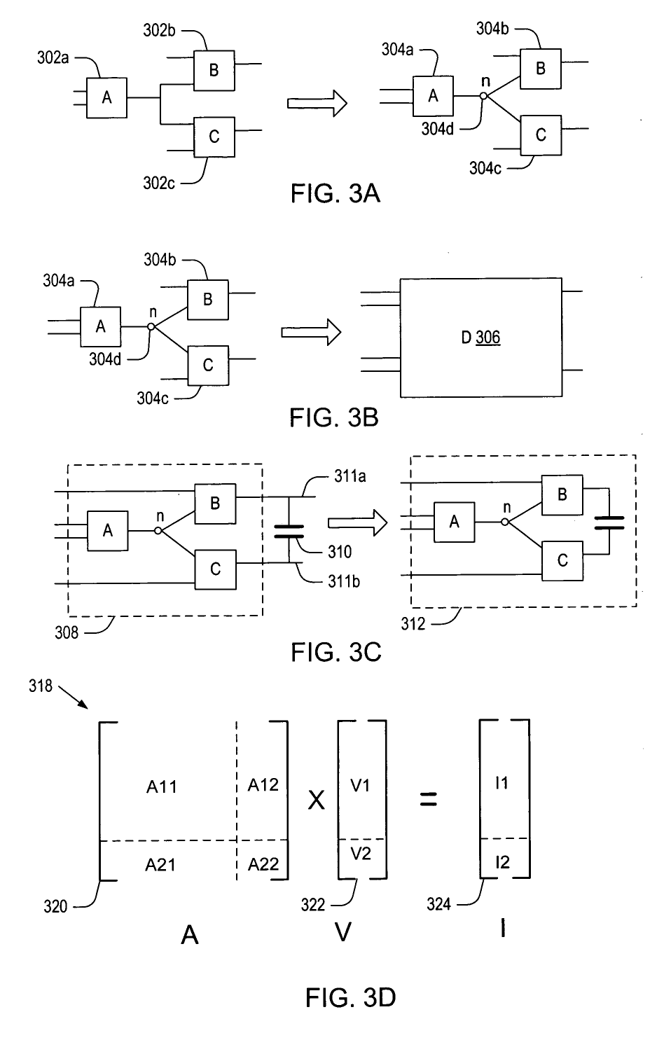

The process may begin in a state 202. In the state 202, a topology for each subcircuit is generated, where the topology includes nodes/elements as vertexes and connection between nodes/elements as edges. Hereinafter, the term element refers to a component of the subcircuit and includes child subcircuits. The child subcircuit refers to an element that is contained in a subcircuit and present on a level of the hierarchy immediately below the subcircuit. The child subcircuit may contain its own child subcircuit(s). Also, the subcircuit is referred to as a parent subcircuit of its child subcircuit(s). By way of example, FIG. 3A illustrates an exemplary step of building a topology for three elements, 302a-302c. As depicted, a node 304d is introduced during the process of building a topology. Then, the process may proceed to a state 204.

In the state 204, the appearance rate of a node, such as 304d in FIG. 3A, in the circuit is determined. As groups of devices with the same topological structure may be recognized as one type of subcircuit, the isomorphic property may be exploited in the simulation. Then, in a state 206, it is determine whether the appearance rate of the node is greater than a preset threshold. Upon positive answer to the state 206, a new subcircuit is created by grouping the elements around the node in s state 208. Also, a new name may be given to the new subcircuit. By way of example, FIG. 3B illustrates the process of creating a new subcircuit D 306, where the subcircuit D includes three elements 304a-c. It is noted that the new subcircuit D 306 includes 6 ports that inherit from the three elements 304a-c. Also, as will be explained later, a new hierarchical level for the new subcircuit D may be injected in the hierarchical structure of the entire circuit. Then, the process may proceed to a state 210 to repeat the steps 204-208 for other nodes.

Subsequently, in the state 212, it is checked if the subcircuit includes a local coupling capacitor. If the answer to the state 212 is negative, the process may proceed to a state 218. Otherwise, the local coupling capacitor may be pushed into the subcircuit and the single connection ports for the capacitors are removed in a state 214. By way of example, FIG. 3C illustrates the step of pushing a local coupling capacitor 310 into the subcircuit 308 and removing two single-connection ports 311a-b from the subcircuit 308, and thereby reducing the complexity of the subcircuit analysis. Then, the process may proceed to a state 216.

In the state 216, the local coupling capacitor of child subcircuits may be recursive removed in the same manner, i.e., the states 212 and 214 are recursively repeated from the current subcircuit to the bottom level of the hierarchical structure. Then, the process may proceed to a state 218.

In the state 218, the subcircuit appearance rate may be determined, where the subscript includes user defined subcircuits and/or new subcircuits generated the states 204-216. Then, a determination as to whether the appearance rate of each subcircuit is less than a predetermined threshold is made in a state 220. If the answer to the state 220 is positive, the process may proceed to a state 226. In the state 226, the subcircuit may be expanded to its parent circuit, i.e., the inverse process of grouping described in the state 208 is performed. If the answer to the state 220 is negative, the process may proceed to a state 222.

In the state 222, it is determined whether the subcircuit is a dummy subcircuit. A dummy subcircuit is a circuit that consists of only one subcircuit and typically generated by poor translation of a subcircuit. As a dummy subcircuit increases the hierarchical complexity without any gain in terms of memory and time for simulation, the dummy circuit is expanded in the state 226. If the answer to the state 222 is negative, the process may proceed to a state 224.

In the state 224, a determination as to whether the conductance matrix of the subcircuit is satisfactory. As discussed above, the simulation of a circuit, i.e., the behavior of a circuit may be modeled and formulated by a set of matrix equations which are loaded and solved repetitively during the simulation. FIG. 3D is an exemplary matrix equation shown at 318, A×V=I, wherein A 320 is a conductance matrix, V 322 is a voltage vector and I 324 is an input current vector for a subcircuit. Each element of the conductance matrix A 320 may correspond to a conductance between two internal nodes/ports. The term port node (or, shortly, ports) refers to a node for communicating information in and out of the subcircuit. Also, the term internal node refers to a node that is located within the subcircuit and is not a port node.

As depicted in FIG. 3D, the conductance matrix 320 may include four sub-matrices. Each element of the sub-matrix A11 corresponds to a conductance between two internal nodes while each element the sub-matrix A22 corresponds to a conductance between two ports of the subcircuit. The sub-matrices A12 and A21 represent conductance matrices between the internal nodes and port nodes. V1 and V2 are the voltages to be calculated at the internal nodes and ports, respectively, while I1 and I2 are input currents at the internal nodes and the ports, respectively. In general, the smaller the dimension of the conductance matrix A, the better conditioned the matrix is in term of memory and time consumed for simulation of subcircuit. Also, for a given dimension, a desirable conduction matrix may have few port nodes, i.e., the dimension of the sub-matrix A11 is much larger than that of the sub-matrix A22. In addition, most of the off-diagonal elements of a well-conditioned sub-matrix A11 may be zeros. If the condition of the conductance matrix 320 is not satisfactory in the state 224, the subcircuit may be expanded in the state 226. Otherwise, the process may proceed to a state 228.

In the state 228, a new name may be assigned to the subcircuit, if required, to obviate any confusion in identifying the subcircuit. Also, if necessary, a new level is injected into the hierarchical structure. Next, one or more parallel subcircuit instances may be merged into one subcircuit with a multiplier in a state 230, where parallel subcircuits have identical ports and each of counterpart ports are connected. By way of example, FIG. 3E illustrates an exemplary step of merging two parallel subcircuit instances 330a-330b into one subcircuit 332 with a multiplier×2. Then, in a state 232, the steps 202-230 may be repeated from the bottom to top level in the hierarchical structure to establish a hierarchical structure of the entire circuit.

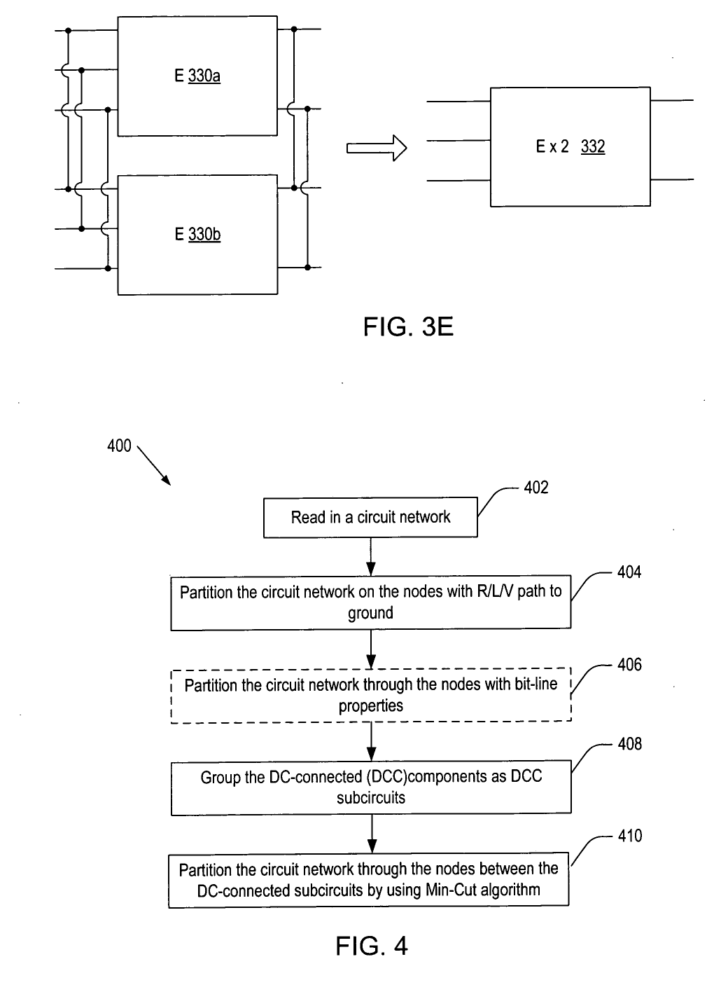

Upon establishment of the hierarchical structure, the circuit may be refined by partitioning. In a MOS circuit, the drivability may be largely limited by the loadings from MOSFETs that are connected to each other. If a large number of MOSFETs are connected to a node through drains or sources, the range of voltage change on that node may be usually small and the node has the bit-line property. If a large number of MOSFETs are connected to a node through gates, the node may have the word-line property. For subcircuits related to memory cells, the bit-line and word-line properties can be used for circuit partition. Typically, the ports of memory cell subcircuit may be either nodes having the bit-line property, nodes having the word-line property, nodes providing VDD or nodes grounded. As such, the subcircuits may be partitioned on the nodes that have R/L/V paths to ground. FIG. 4 shows a flow chart shown at 400 and illustrates the exemplary steps of partitioning a circuit in accordance with the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like.

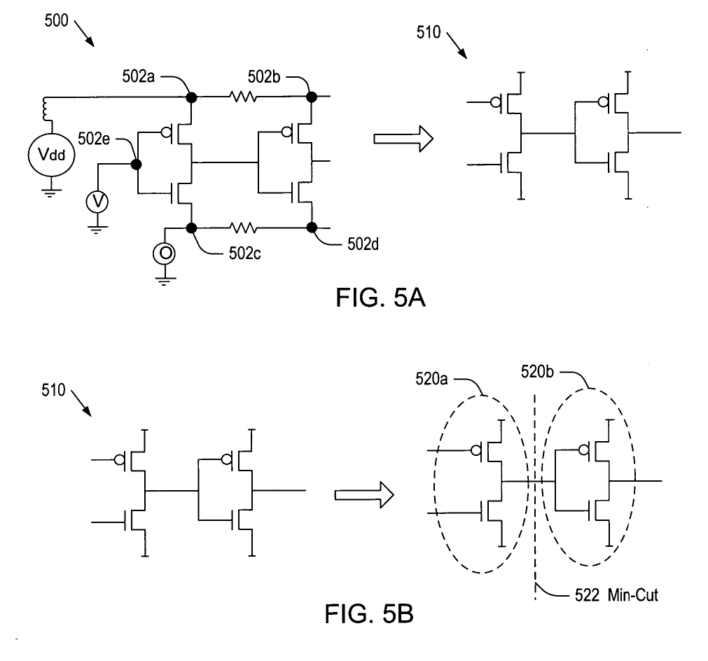

The process may begin in a state 402. In the state 402, a circuit is read in, wherein the circuit may be in a hierarchical structure or flat. Next, in a state 404, the circuit is partitioned on the nodes that have R/L/V paths to ground as illustrated in FIG. 5. As depicted, the circuit shown at 500 includes five nodes 502a-e that are connected to the ground via R/L/V paths. The circuit 500 may be partitioned on these nodes to transform into a simplified circuit 510. Then, the process may proceed to an optional state 406.

In the state 406, the circuit may be further partitioned on the nodes that have the bit-line property so that the memory cells will not be all grouped together by state 408. Then, in a state 408, DC-connected (DCC) components may be grouped as a subcircuit. By way of example, FIG. 5B illustrates an exemplary step for grouping the subcircuit 510 into two subcircuits 520a-b, wherein each of the subcircuits 520a-520b includes DCC components. Subsequently, in a state 410, the two DCC subcircuits 520a-520b may be partitioned by use of the Min-Cut algorithm, which is depicted by a line 522 in FIG. 5B. Typically, the Min-Cut algorithm may be applied to select the optimal cut node to decompose subcircuits into isolated groups such that the maximum group size is minimized. The Min-Cut algorithm is well known in the art and, for instance, U.S. Pat. No. 6,577,992 discusses about this algorithm. It is noted that the Min-Cut algorithm may be applied to each hierarchical level in the present application.

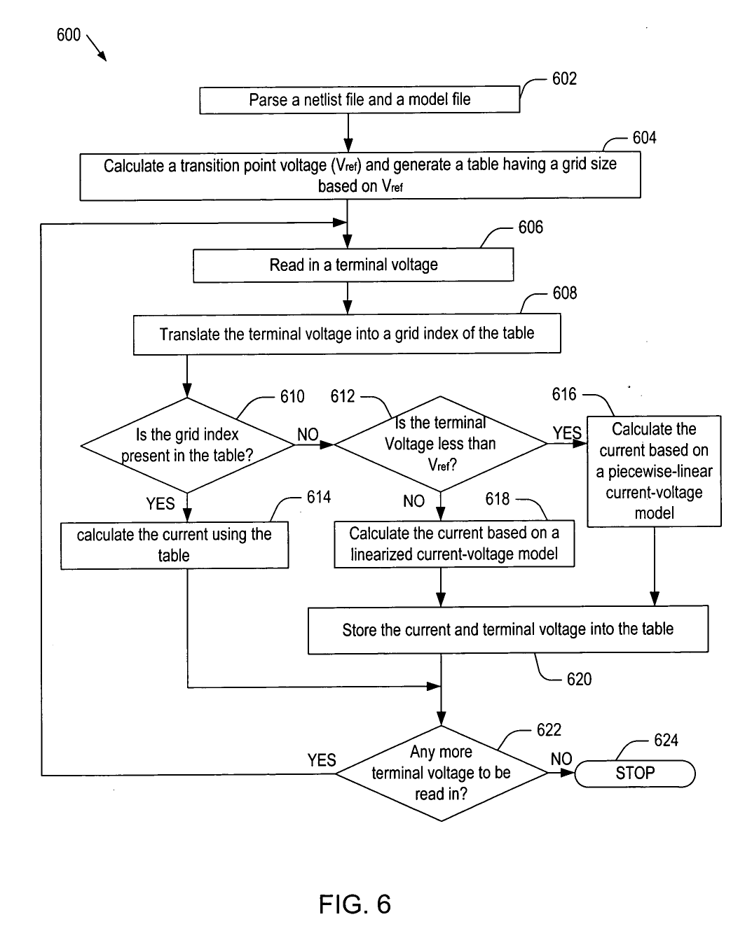

Upon completion of partitioning the circuit, the circuit behavior may be simulated by solving a matrix equation, wherein the matrix equation includes a conductance matrix of the circuit. To load the conductance matrix, each of the matrix elements needs to be calculated based on the behavior of MOS devices that are related to the matrix element. For a linear element, such as resistor, the conductance may be the inverse of the resistance. For a linear capacitor, the conductance may be the capacitance multiplied by the operating frequency, which may be specified by the user. For a non-linear element, such as MOS transistor, the conductance may be calculated by taking a partial derivative of current with respect to voltage at its terminals, which may be a time consuming process due to the non-linearity of the current-voltage characteristics. One approach to reduce the computational time of partial derivatives may be utilizing one or more dynamic current-voltage (I-V) tables for the nonlinear element. FIG. 6 is a flow chart shown at 600 and illustrates the steps that may be carried out to dynamically model MOS tables in accordance with the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like.

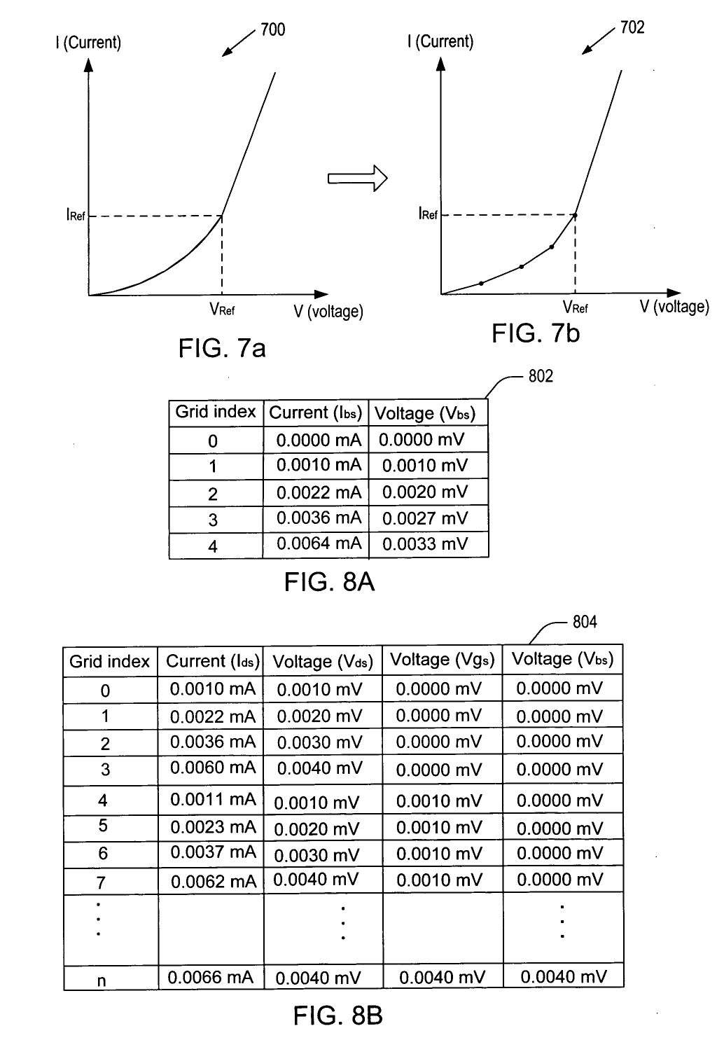

The process may begin in a state 602. In the state 602, a netlist file and a model file are read in and parsed, where the model file may contain parameters for describing the behavior of MOS devices. From these data files, the current-voltage characteristics between two terminals of each MOS device may be obtained. By way of example, FIGS. 7A-7B illustrate an exemplary piecewise-linear approximation of the current-voltage curve for a MOS diode in accordance with the present invention. As depicted in FIG. 7A, the current between two terminals of a MOS diode is not a linear function of the voltage between the two terminals. Also, as will be described in connection with FIGS. 7B, and 8A-8B, some of the data points on the curve 700 in FIG. 7A may be piecewise-linearized and stored in a table. The process may proceed from the state 602 to a state 604.

In the state 604, the transition-point voltage Vref (or, equivalently, a dynamic-point voltage) may be determined by use of the curve 700 and a predetermined dynamic-point current, Iref. By way of example, the curve 702 in FIG. 7B may be divided into two regions: a piecewise-linear current region (<Vref) and a linear current region (≧Vref). The piecewise-linear current region may be approximated by four linear segments. FIG. 8A represents a table 802 for the I-V curve 702 in FIG. 7B, wherein each of the grid indices of the table 802 corresponds to a point on the curve in the piecewise-linear current region. It is noted that, in the state 604, the grid size of the table may be determined based on Vref, the degree of accuracy and memory size for storing the table. Hereinafter, the term “grid size” (or, equivalently, grid density) may refer to the number of data points in the table 802. A skilled artisan would appreciate that the various current-voltage curves, such as body-drain and body-source curves, can be generated in the same manner as described in FIGS. 7A-8A.

FIG. 8B is an exemplary table 804 for a MOSFET device. As depicted, the drain-source current (Ids) may be a function of three voltages: drain-source voltage (Vds), gate-source voltage (Vgs) and body-source voltage (Vbs). Accordingly, each row of the table 804 may correspond to a value of drain-source current (Ids) at a given set of three voltage values. Typically, an I-V curve for a MOSFET has an exponential shape and may require more than two regions to accurately approximate the entire I-V curve. For example, the curve may be split into three regions: a linearized current region (>Vref), a piecewise-linear region (or, compact current region) and a saturation region, wherein a voltage for the piecewise-linear region and saturation region is less than the transition-point voltage Vref.

It is noted that FIGS. 8A-8B illustrate I-V tables for exemplary subcircuits; a MOD device and MOSFET. However, it should be apparent to those of ordinary skill that I-V curve for each subcircuit can be generated in the similar manner based on the information of circuit elements contained in the subcircuit. Then, the process may proceed from the state 604 to a state 606.

In the state 606, a terminal voltage for a device may be input. Next, in a state 608, the terminal voltage is translated into a grid index of a table. If the device is a MOS diode, a table similar to the table 802 in FIG. 8A may be used in the state 802. Likewise, if the device is a MOSFET, a table similar to the table 804 in FIG. 8B may be used. Then, the process may proceed to a state 610.

In the state 610, it is determined whether the translated grid index is present in the table. If the answer to the state 608 is positive, the current corresponding to the grid index is read from the table in a state 614. Then, the process may advance to a state 622. Otherwise, the process may proceed to a state 612. In the state 612, a determination as to whether the terminal voltage is less than the transition-point voltage Vref may be made. Upon positive answer to state 612, the current is calculated based on the piecewise-linear I-V model, i.e., an interpolation between two grid index points may be performed. Then, the process may proceed to a state 620. If the answer to the state 612 is negative, the current may be calculated by the linearized current-voltage model in a state 618. Then, the process may proceed to the state 620. In the state 620, the calculated current and terminal voltage may be stored in the table for later use, i.e., the grid size of the table is increased by one. It is noted that the state 620 may increase the size of I-V table by one, i.e., the size is changed dynamically. As will be explained later, the conductance matrix may be loaded each time step of a transient simulation. Thus, the I-V tables are dynamically updated during the simulation providing an advantage in terms of memory and time consumed for the simulation. The process may proceed from the state 620 to a state 622.

In the state 622, a determination as to whether there is any more terminal voltage to be read in may be made. Upon negative answer to the state 622, the process may stop in a state 624. Otherwise, the process may proceed to the state 606 and repeat the steps 606-622.

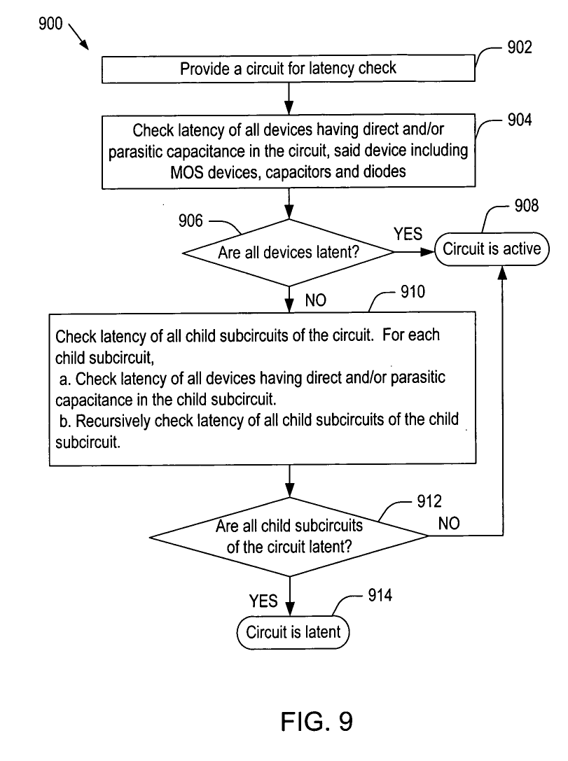

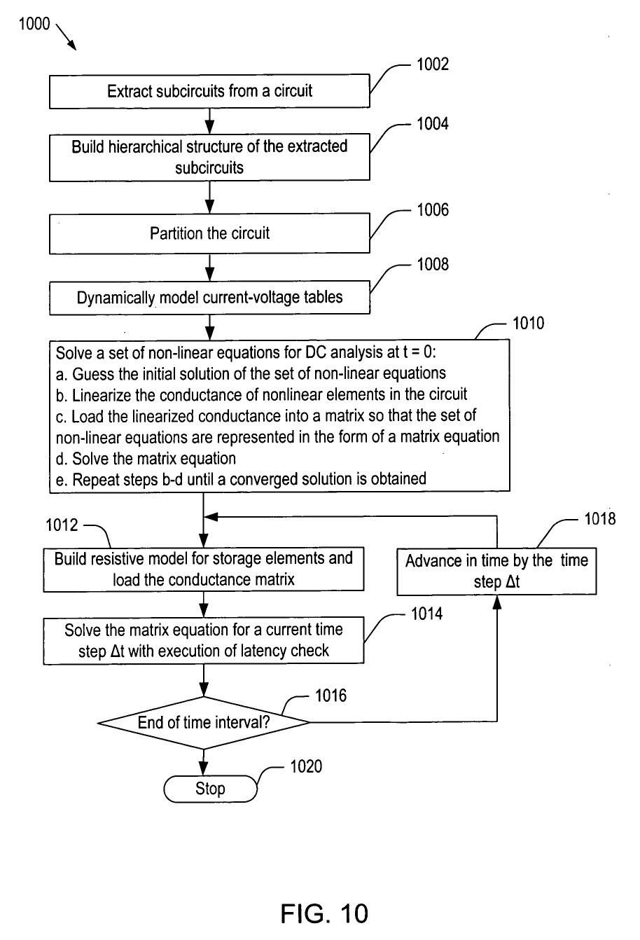

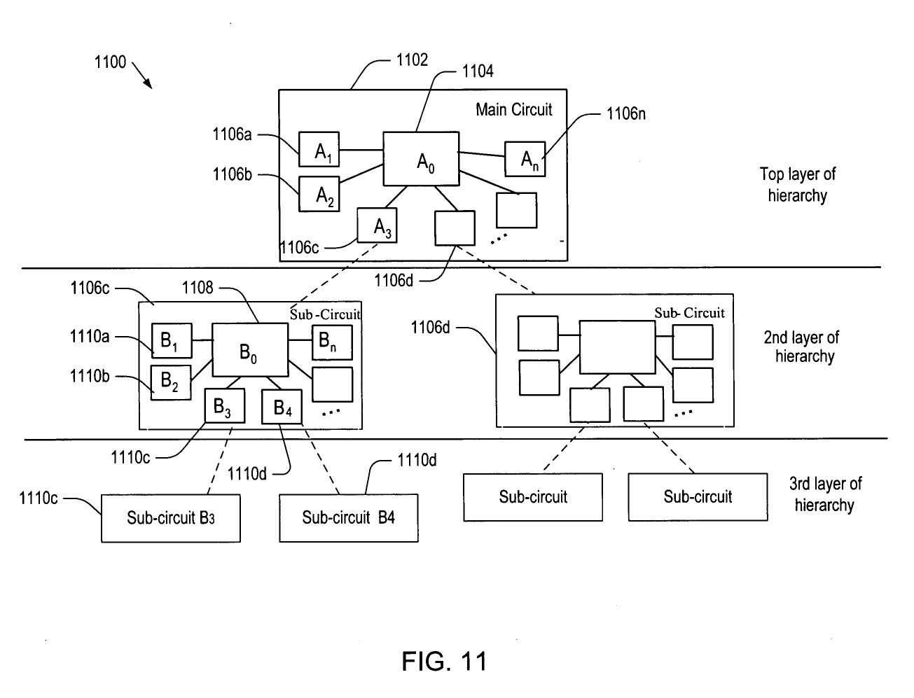

The behavior of a circuit may be simulated if MOS tables for the elements in the circuit are generated following the process described with reference to FIG. 6. A further detailed description of the simulation will be given in connection with FIG. 10. To reduce the time and memory consumed by the simulation, a latency check of the circuit may be performed in tandem with the simulation. FIG. 9 is a flow chart shown at 900 and illustrates the steps that may be carried out to hierarchically check latency in accordance with the present invention. Hereinafter, a circuit is considered latent if the maximum change of the nodal voltage(s) of the circuit in time and/or the maximum capacitive current in time is less than a preset threshold. A capacitive current is the current flowing through a device of the circuit. By way example, the capacitive current over a capacitor may be defined as the derivative of charge with respect to time. The circuit is latent only if all of its child subcircuits and devices are latent, i.e., the maximum capacitive current of the devices contained in the circuit is less than a preset threshold.

The process may begin in a state 902. In the state 902, a circuit having a hierarchical structure is provided for a latency check. Hereinafter, the circuit may refer to the entire portion of the circuit or a subcircuit at any level of the hierarchical structure. Then, in a state 904, the latency of all devices having direct or parasitic capacitance is checked, where the devices may include MOS devices, capacitors, and diode, for example. Subsequently, it is checked whether these devices are latent in a state 906. Upon positive answer to the state 906, the process may proceed to a state 908 to end the latency check with a conclusion that the circuit is active.

If the answer to the state 910 is negative, the process may proceed to a state 910. In the state 910, the latency of all child subcircuits contained in the circuit is checked. In the state 910, two steps are performed for each child subcircuit: 1) all devices having direct or parasitic capacitance in the child subcircuit is checked for latency, and 2) all of the child subcircuits of the child subcircuit are checked for latency recursively toward the bottom level of the hierarchical structure. Then, the process may proceed to a state 912.

In the state 912, it is determined whether all child subcircuits contained in the circuit are latent. If the answer to the state 912 is positive, the process may end in a state 914 concluding that the circuit is latent. Otherwise, the process may proceed to the state 908.

As discussed above, a latency check may be performed in tandem with a transient analysis of a circuit. FIG. 10 is a flow chart shown at 1000 and illustrates the steps that may be carried out to perform a transient analysis in accordance with the present invention. A transient analysis may be applied to evaluate the signal behavior of linear/nonlinear circuits as a function of time. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like.

The process may begin in a state 1002. In the state 1002, subcircuits may be extracted according to the steps depicted in FIG. 1. Then, in a state 1004, a hierarchical structure for the extracted subcircuits may be build according to the steps depicted in FIG. 2. Thus, upon completion of the state 1004, the circuit may have a hierarchical structure. Subsequently, in a state 1006, a partitioning of the circuit in the hierarchical structure may be performed according to the steps depicted in FIG. 2. FIG. 11 is an exemplary circuit shown at 1100 that has a hierarchical structure generated by performing the states 1002-1006. For simplicity, the circuit 1100 is shown to have only three hierarchical levels. But, it should be apparent to those of ordinary skill that any suitable number of hierarchical levels may be used without deviating from the spirit of the present teachings.

In FIG. 11, the main circuit 1102 may be grouped into n child subcircuits A1-Δn, 1106a-1106n, and one additional subcircuit A0 that includes elements not included in the child subcircuits A1-An. One of the child subcircuits, say A1 1106c, may include its own child subcircuits B1-Bn, 1110a-1110n, and one additional subcircuit B0 1108 that includes elements not includes in the child subcircuits B1-Bn.

Upon partitioning the circuit in each of the hierarchical levels, the process may proceed from the state 1006 to a state 1008. In the state 1008, a current-voltage (I-V) table of each MOS device may be generated according to the steps described in FIG. 6. It is noted that the I-V table may be updated during further simulation of the transient behavior of the circuit. Then, the process may proceed to a state 1010.

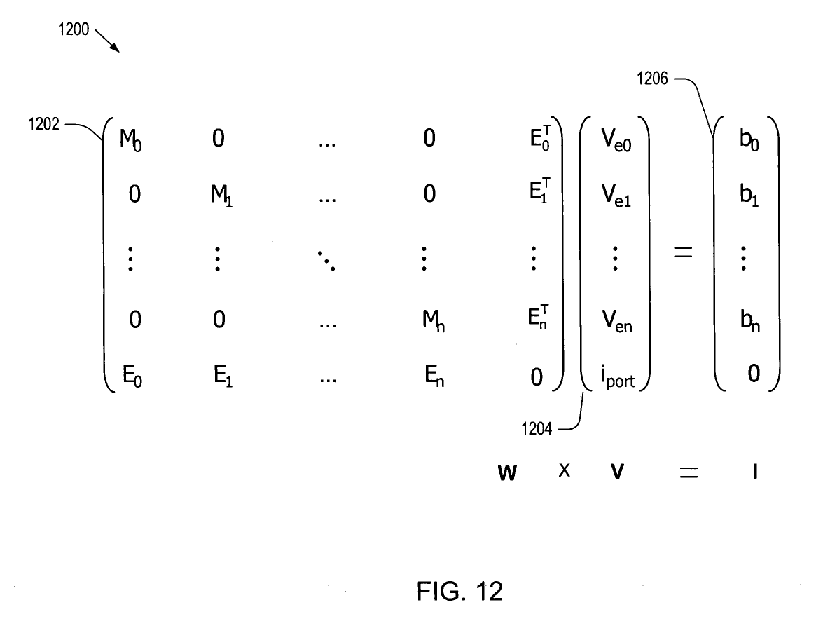

In the state 1010, a DC analysis (or, equivalently, DC initialization) for the circuit 1100 may begin. The DC analysis may be performed to obtain the state at time t=0 (or, equivalently, the initial condition) and may be implemented as a special case of the transient simulation. As will be discussed, the transient simulation may correspond to the states 1012-1018. The DC analysis in the state 1010 may include several steps and begin with an initial guess of the non-linear equation, where the initial guess may be the terminal voltage values at the ports of the circuit. Then, the conductance of non-linear elements in the circuit may be linearized. For example, a MOSFET may be a non-linear element and have four terminals. A current-voltage table generated in the state 1008 may be used to calculate the partial derivative of current with respect to voltage yielding the conductance between two terminals of the MOSFET. Next, the linearized conductance may be loaded in a conductance matrix of the circuit 1100 so that the non-linear equations may be represented in the form of a matrix equation. FIG. 12 illustrates an exemplary matrix equation 1200 for simulating the circuit 1100 in FIG. 11. More detailed description of the matrix equation in FIG. 12 will be given later. The matrix equation 1200 may be solved by iterating the steps b-d of the state 1010 until a converged solution is obtained or the number of time steps exceeds a pre-determined iteration number. Preferably, the Newton-Raphson method may be used in the iteration. It is noted that the input source current 1206 of the matrix equation 1200 in FIG. 12 may remain fixed during the iteration process.

Upon solving the non-linear equations for DC analysis at time t=0 in the state 1010, a transient analysis may begin in a state 1012. Typically, the transient analysis may be performed at each incremental time step Δt. The input source current 1206, i.e., the RHS of the matrix equation 1200 in FIG. 12, may be changed at each time step. In the state 1012, resistive models for storage elements, such as capacitor and inductor, may be determined using the time step Δt or, equivalently, a frequency f=1/Δt. Also, the conductance matrix W 1202 in FIG. 12 may be loaded in the state 1012. It is noted that the process of loading the conductance matrix may require that the current-voltage tables for MOS devices and MOSFETs in the circuit be dynamically updated as described in FIG. 6. Then, the process may proceed from the state 1012 to a state 1014.

In the state 1014, the matrix equation 1200 may be solved to obtain the transient solution at the current time step. As in the case of DC analysis at time t=0, the Newton-Raphson method may be used to solve the matrix equation 1200. To reduce the computational time for simulating each transient behavior, the hierarchical latency check as described in FIG. 6 may be executed in the state 1014. Then, the process may proceed to a state 1016.

In the state 1016, it is determined whether the end of time interval has reached. Upon negative answer to the state 1016, the process may proceed to a state 1018 to advance in time by the time step Δt. Subsequently, the process may proceed to the state 1012. If the answer to the state 1016 is positive, the process may stop in a state 1020. It is noted that the circuit simulation described in FIG. 10 is advantageously accomplished by traversing a hierarchical data structure without flattening the hierarchical data structure.

As discussed above, the simulation process may advance in time by the time step Δt in the state 1018. As an alternative, a multirate algorithm may be used to allow each subcircuit to have its own time step Δt so that the simulation accuracy may be controlled as needed.

As discussed above, the matrix equation 1200 in FIG. 12 may correspond to a set of non-linear equations established at each time step of the transient simulation for the circuit 1100 in FIG. 11. The conductance matrix W 1202 for the main circuit 1102 at the top hierarchical level may include a set of block matrices: M0 for the subcircuit A0 that includes elements not included in the child subcircuits A1-An, and M1-Mn for the child subcircuits A1-An, respectively. Each of the block matrices M0-Mn, say Mi, may be the conductance matrix between two ports of the i-th subcircuit Ai. It is noted that each subcircuit has been replaced by macro-modeling, i.e., the electrical behavior of each subcircuit is characterized and modeled by a corresponding sub-matrix. When a subcircuit is latent at a time step in the transient simulation of FIG. 10, it is not necessary to rebuild the macro-model of the subcircuit at the subsequent time step, i.e., the corresponding sub-matrix is reused at the subsequent time step of the transient simulation. The matrix W 1202 may also include adjacent block matrices E10-En, wherein an adjacent matrix Ei may represent a conductance matrix between the ports of i-th subcircuit Ai and a set of global nodes. The solution vector V 1204 may include sub-vectors, Ve0-Ven, where each of the sub-vectors, say Vei, may be a voltage vector at the port nodes of the i-th subcircuit Ai. The RHS vector I 1206 may include sub-vectors b0-bn, wherein each sub-vector may be an input current at the port nodes of the corresponding subcircuits.

During each time step of the transient simulation in the state 1014 of FIG. 10, the matrix equation 1200 may be solved for a given input vector I 1206 and newly loaded matrix W 1202. To reduce the computational time, the simulation may flow from the top hierarchical level to the bottom device while a hierarchical latency check may be performed at each hierarchical level. As the first step of the simulation, a matrix equation 1200 may be established for the main circuit 1102. Upon calculating the solution vector V 1204 at n-th time step, the solution vector V at n-th time step may be compared with that of (n−1)-th time step. If the maximum change in a sub-vector, say V0i, is less than a preset threshold, the i-th subcircuit is considered latent. In such a case, the sub-matrix A0i may not need to be updated for simulation at the next (n+1)-th time step. If a subcircuit, say the subcircuit A3 1106c in FIG. 11, is active, i.e., the solution sub-vector Ve3 and/or the capacitive current through an element of the subcircuit A3 has a change greater than a threshold, the subcircuits A3 may need to be simulated further in detail. To do so, a matrix equation 1200 for the subcircuits A3 may be loaded. In this case, each of the sub-matrices M1-Mn may correspond to one of the subcircuits B0-Bn 1110. Upon calculating the solution vector V 1204, a similar latency check may be performed to find the active subcircuits. To complete the simulation at the n-th time step, the simulation of the circuit 1100 needs to recursively performed from the top level to the bottom level (or, equivalently, device level) of the hierarchical structure. At the bottom level, the conductance matrix may correspond to ports and internal nodes, i.e., the matrix equation 1200 may be similar to the matrix equation 318.

It is noted that the simulation process described in FIG. 10 may reduce the computation time since only active subcircuits are simulated. Also, the conductance matrices of the latent subcircuits are copied from the previous time step. In a typical circuit simulation, the active pin ratio can be only few percent, i.e., a small portion of the input pins is activated. Thus, a large portion of the circuit may be latent and, as a consequence, the simulation process described in FIG. 10 may result a significant performance advantages in memory usage as well as computational speed over traditional circuit simulators using the flat approach.

It should be understood, of course, that the foregoing relates to exemplary embodiments of the invention and that modifications may be made without departing from the spirit and scope of the invention as set forth in the following claims.

What is claimed is:

1. A method for simulating a behavior of a circuit, comprising:
extracting one or more subcircuits from a circuit;
establishing a hierarchical structure of the extracted subcircuits;
partitioning the circuit to refine the established hierarchical structure;
dynamically modeling a current-voltage table for each of said subcircuits; and
performing a transient analysis of an active portion of the circuit at each incremental time step, said transient analysis including a recursive latency check from the top level to the bottom level of the hierarchical structure to determine the active portion of the circuit and updating the active portion based on the current-voltage table.

2. A method for simulating a behavior of a circuit as recited in claim 1, wherein the step of extracting one or more subcircuits includes:
parsing a netlist file of the circuit;
removing parasitical elements from the circuit;
renumbering terminals of one or more MOS devices contained in the circuit to construct a pure-MOS-circuit;
categorizing the MOS devices into PMOS devices and NMOS devices;
sorting the categorized MOS devices by the order of the renumbered terminals; and
extracting one or more types of MOS devices from the sorted MOS devices as subcircuits.

3. A method for simulating a behavior of a circuit as recited in claim 2, wherein the step of extracting one or more subcircuits further includes:
extracting inverters from the sorted MOS devices;
sorting the inverters by the order of input and output terminal numbers thereof;
extracting latches from the sorted inverters;
extracting latch-based memory cells from the latches;
extracting non-latch-based memory cells;
sorting the NMOS and PMOS devices by the order of drain and source terminal numbers thereof;
extracting transmission-gates; and
extracting DC-connected component groups from the sorted MOS devices, each of the groups including a plurality of MOS devices connected to each other via source or drain.

4. A method for simulating a behavior of a circuit as recited in claim 3, wherein the step of extracting latch-based memory cells includes:
identifying the extracted latches that have bit-line and word-line properties; and
grouping the identified latches as latch-based memory cells.

5. A method for simulating a behavior of a circuit as recited in claim 1, wherein the step of establishing a hierarchical structure includes:
(a) building topology with nodes of the circuit and the extracted subcircuits;
(b) selecting one of the nodes;
(c) determining an appearance rate of the selected node;
if the appearance rate is greater than a predetermined threshold,
(d) creating a new subcircuit by grouping one or more of the extracted subcircuits around the selected node; and
(e) repeating the steps (a)-(d) for each of the nodes to build the hierarchical structure from the bottom level to the top level thereof.

6. A method for simulating a behavior of a circuit as recited in claim 5, wherein the step of establishing a hierarchical structure further includes:
(f) selecting a particular one amongst entire subcircuits including the extracted subcircuits and created new subcircuits;
(g) determining if the particular subcircuit has a local coupling capacitor;
if the particular subcircuit has a local coupling capacitor,
(h) pushing the local coupling capacitor into the particular subcircuit; and
(i) removing a single connection port; and
(j) repeating the steps (f)-(i) for each of the entire subcircuits.

7. A method for simulating a behavior of a circuit as recited in claim 5, wherein the step of establishing a hierarchical structure further includes, prior to the step of repeating the steps (f)-(j):
determining an appearance rate of the particular subcircuit;
determining whether the particular subcircuit is a dummy subcircuit;
determining whether a conductance matrix of the particular subcircuit is satisfactory; and
if the appearance rate of the particular subcircuit is less than a preset threshold or the particular matrix is a dummy subcircuit or the conductance matrix is not satisfactory,
expanding the particular subcircuit up to its parent circuit in the hierarchical structure;
otherwise,
assigning a new name to the particular subcircuit if the particular subcircuit is a new subcircuit; and
injecting a new hierarchical level into the established hierarchical structure if the particular subcircuit is a new subcircuit.

8. A method for simulating a behavior of a circuit as recited in claim 7, wherein the step of determining whether a conductance matrix of the particular subcircuit is satisfactory is performed by comparing the number of internal nodes with the number of ports of the particular subcircuit.

9. A method for simulating a behavior of a circuit as recited in claim 5, wherein the step of establishing a hierarchical structure further includes:
merging parallel subcircuit instances by use of a multiplier.

10. A method for simulating a behavior of a circuit as recited in claim 1, wherein the step of partitioning the circuit includes:
reading in a circuit network of the circuit;
partitioning the circuit network at one or more nodes that have resistor/inductor/voltage-source (R/L/V) paths to ground; and
grouping a set of DC-connected components as a new subcircuit.

11. A method for simulating a behavior of a circuit as recited in claim 10, wherein the step of partitioning the circuit further includes, prior to the step of grouping:
partitioning the circuit network at nodes that have bit-line properties.

12. A method for simulating a behavior of a circuit as recited in claim 1, wherein the step of dynamically modeling a current-voltage table for each of said subcircuits includes:
parsing a model file containing parameter information of the circuit;
selecting a particular one amongst the extracted subcircuits;
calculating a transition point voltage of the particular subcircuit using the parameter information;
generating a table having a plurality of grid indices, the size of said grid indices being determined using the transition point voltage, each of the grid indices corresponding to a row of the table and including a current value and at least one voltage value;
reading in a terminal voltage;
translating the terminal voltage into a target grid index;
determining if the target grid index is present in the grid indices; and
if the target grid index is not present in the grid indices,
calculating a terminal current based on the terminal voltage; and
storing the terminal current and terminal voltage into the table.

13. A method for simulating a behavior of a circuit as recited in claim 12, wherein the step of calculating a terminal current includes:
determining if the terminal voltage is less than the transition point voltage; and
if the terminal voltage is less than the transition point voltage,
calculating the terminal current based on a piecewise-linear current-voltage model, otherwise,
calculating the terminal current based on a linear current-voltage model.

14. A method for simulating a behavior of a circuit as recited in claim 1, wherein the step of performing a transient analysis includes:
(a) building resistive models for storage elements of the circuit;
(b) loading a conductance matrix of the circuit based on the resistive models;
(c) solving a matrix equation containing the loaded conductance matrix;
(d) executing said recursive latency check on the circuit to find the active portion of the circuit;
(e) rebuilding a portion of the resistive models corresponding to the active portion; and
(f) repeating the steps (b)-(e) at each incremental time step.

15. A method for simulating a behavior of a circuit as recited in claim 14, wherein the step of executing a recursive latency check includes:
(g) determining whether each of child subcircuits of the circuit is active by comparing a current solution of the conductance matrix equation with a previous solution obtained at a previous time step and
if any particular child subcircuit is active,
(h) loading a sub-conductance matrix for the particular child subcircuit;
(i) solving a sub-matrix equation for the sub-conductance matrix; and
(j) repeating steps (g)-(i) recursively from the top level to the bottom level of the hierarchical structure.

16. A method for simulating a behavior of a circuit as recited in claim 15, wherein the current solution includes nodal voltages, capacitive currents, charge of capacitors and fluxes of inductors.

17. A method for simulating a behavior of a circuit as recited in claim 1, wherein a multi-rate algorithm is used to allow each of the subcircuits to have an individual incremental time step.
